(19) United States
(12) Patent Application Publication
(10) Pub. No.: US 2008/0091352 A1
(43) Pub. Date: Apr. 17, 2008

(54) Automobile collision avoidance system

(76) Inventor: James K. O'Hare, Newport Beach, CA (US)

Correspondence Address: JAMES K. O'HARE, 1135 BAYPOINTE DRIVE, NEWPORT BEACH, CA, 92660, US

(21) Appl. No.: 11/546,098

(22) Filed: Oct. 11, 2006

(51) Int. Cl. G08G 1/16

(52) U.S. Cl. 701/301; 342/455; 340/903; 340/436

(57) ABSTRACT

A navigation system and a wireless communication device are installed on an automobile. The navigation system determines the state vector of the automobile. The navigated state vector is periodically transmitted by the wireless communication device for use by other vehicles. The wireless communication device also receives state vectors transmitted from neighboring vehicles. The received state vectors are compared with the automobile's current state vector by a processor. The processor drives a display that displays the relative position of the neighboring vehicles. The processor also determines the likelihood of collision with another vehicle. The processor issues display or audio cues to alert the driver. The processor may also send brake or steering commands when a driving correction should be made.

### BACKGROUND

1. Field

The invention relates to automobile safety. More particularly, the invention relates to automobile safety systems for collision avoidance.

2. Background

Navigation systems have become smaller, more accurate and more affordable in recent years. The global positioning system (GPS) is a satellite based navigation system having a constellation of satellites that broadcast precise timing signals. The timing signals can be received and processed to determine the precise time and geodetic position and velocity of the receiver. An inertial navigation system (INS) is a navigation system having angular sensors and accelerometers. The angular sensors measure angular position, angular rates, or both. The accelerometers measure accelerations that are integrated over time to determine changes in velocity and position.

A GPS receiver, an INS, or both may be used in moving vehicles to estimate a vehicle state. The vehicle state can be expressed in the form of a vector. The state vector is a vector having one or more elements that describe the vehicle state. The state vector could include for example the vehicle's position (i.e. latitude, longitude, and elevation), velocity, acceleration, and angular position (i.e. pitch, roll, and heading). Vehicles having both a GPS receiver and an INS frequently use a Kalman filter algorithm or other state estimation algorithm to blend the GPS and INS state vectors to produce a very accurate blended state vector. The advent of GPS chip technologies and inertial Microelectromechanical system (MEMS) technologies make many GPS receivers and INSs small and affordable.

Wireless communications devices have also become smaller and more affordable. Promulgation of wireless standards such as IEEE 802.11 has enabled manufacturers to produce wireless communication devices that are interoperable with a variety of other types of wireless communication devices. These inexpensive wireless communication devices are frequently used to transmit and receive data through wireless networks. The popularity of these devices has led to market forces that have driven manufacturers to produce smaller and more affordable wireless communication devices.

Automobile collisions kill approximately 1.2 million people each year. Many of these collisions are a result of a lack of situational awareness by the driver. Poor situational awareness may be caused weather conditions such as fog, mirror blind spots or physical obstructions. Driver distraction and inattentiveness may also contribute to lack of situational awareness. Automobile safety systems such as mirrors, turn signals and lights provide the driver with enhanced awareness but are ineffective in many situations. This results in a significant number of automobile collision casualties.

The large number of automobile collision casualties demonstrates that there is a need for better safety systems that reduce the number and severity of automobile collisions. Applicant's invention addresses this need.

### SUMMARY

A navigation system and wireless communication device are installed in an automobile. The navigation system determines the automobile state and outputs the state vector. The wireless communication device transmits the state vector for use by neighboring automobiles. The wireless communication device also receives the state vectors of neighboring vehicles. A processor compares the automobile's state vector with the state vectors of neighboring vehicles. The processor may generate situational awareness symbology for a display, provide audio commands for audio cuing device; or issue commands to the vehicle braking or steering systems.

### BRIEF DESCRIPTION OF THE DRAWINGS

Claimed subject matter is particularly pointed out and distinctly claimed in the concluding portion of the specification. However, such subject matter may be understood by reference to the following detailed description when read with the accompanying drawings in which:

FIG. 1 is a block diagram showing an embodiment of the present invention.

FIG. 2 is a block diagram showing an embodiment of the processor shown in FIG. 1.

FIG. 3 shows the contents of an exemplary state vector processed in the processor in FIG. 2.

FIG. 4 shows a first exemplary driver display page for the display shown in FIG. 1.

FIG. 5 shows a second exemplary driver display page for the display shown in FIG. 1.

FIG. 6 shows a third exemplary driver display page for the display shown in FIG. 1.

### DETAILED DESCRIPTION

Methods and apparatus that implement the embodiments of the various features of the disclosure will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

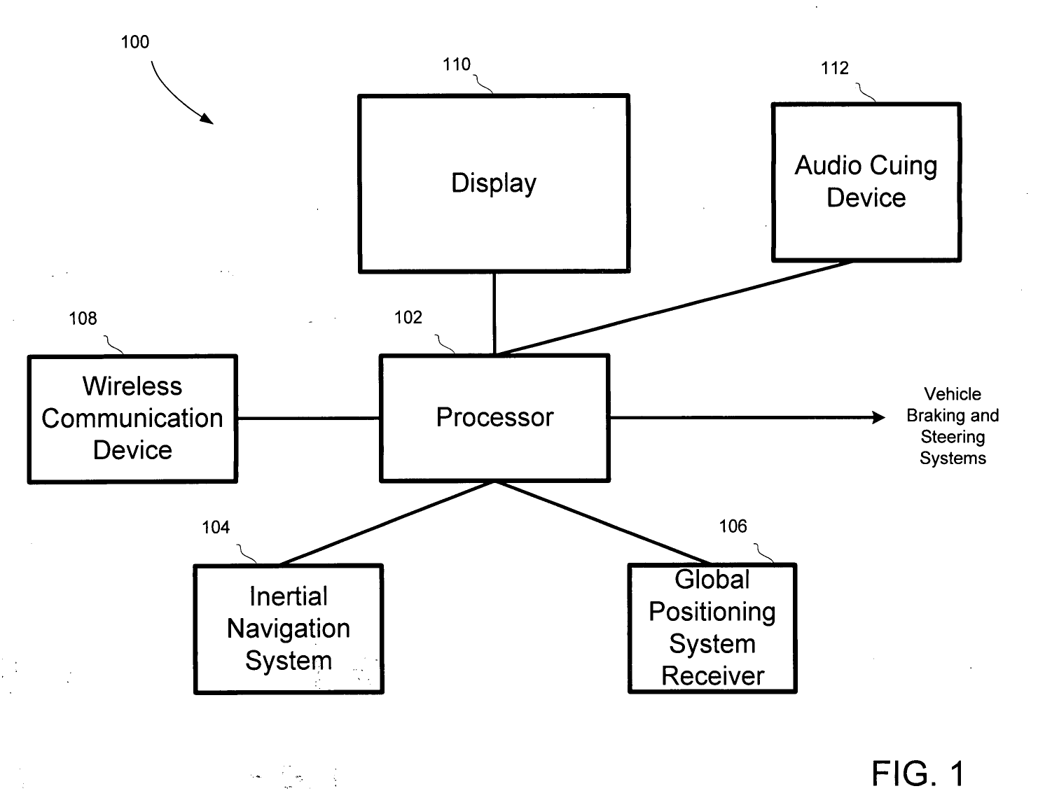

FIG. 1 shows a block diagram of an embodiment of the automobile collision avoidance system (ACAS). The ACAS is controlled by a processor 102. The processor 102 is connected with an inertial system (INS) 104 and a global positioning system (GPS) receiver 106 that generate navigation information. The processor 102 is also connected with a wireless communication device 108 that transmits and receives digital data. The processor 102 drives a display 110 and an audio cuing device 112 for alerting a driver. The processor 102 provides control inputs to the automobile's braking and steering systems (not shown).

This embodiment includes complementary navigation systems, the INS 104 and the GPS receiver 106. Alternate, embodiments may feature an integrated GPS and INS navigation system or other navigation system. The use of only an INS 104 or only a GPS receiver 106 as the sole source of navigation information is also contemplated.

A display 110 and an audio cuing device 112 provide both visual and audio situational awareness information to a driver. Alternate embodiments may feature only a display 110 or only an audio cuing device 112 as the sole source of ACAS information for the driver. Embodiments that interact directly with the braking and steering systems that provide no ACAS information to the driver are also contemplated.

The INS 104 supplies the processor 102 with navigation information derived from accelerometers and angular position or angular rate sensors. The processor 102 may also provide the INS 104 with initial position data or periodic position updates that allow the INS 104 to correct drift errors, misalignment errors or other errors.

The INS 104 may be a standard gimbal or strapdown INS having one or more gyroscopes and substantially orthogonally mounted accelerometers. Alternatively, the INS 104 may have accelerometers and microelectromechanical systems (MEMS) that estimate angular position or angular rates. An INS 104 having a gyroscope for detecting automobile heading and a speed sensor is also contemplated.

The GPS receiver 106 supplies the processor 102 with navigation information derived from timing signal received from the GPS satellite constellation. The processor 102 may provide the GPS receiver 106 with position data to allow the GPS receiver 106 to quickly reacquire the timing signals if the timing signals are temporarily unavailable. GPS timing signal may be unavailable for a variety of reasons, for example, antenna shadowing as a result of driving through a tunnel or an indoor parking garage. The GPS receiver 106 may also have a radio receiver for receiving differential corrections that make the GPS navigation information even more accurate.

The INS 104 and the GPS receiver 106 are complementary navigation systems. The INS 104 is very responsive to changes in the trajectory of the automobile. A steering or braking input is sensed very quickly at the accelerometers and the angular position sensors. INS 104 position and velocity estimates, however, are derived by integrating accelerometer measurements and errors in the estimates accumulate over time. The GPS receiver 106 is not generally as responsive to changes in automobile trajectory but continually estimates position very accurately. The use of both the INS 104 and the GPS receiver 106 allows the processor 102 to estimate the automobile's state more accurately than with a single navigation system.

The wireless communication device 108 receives the automobile's navigated state vector from the processor 102. The wireless communication 108 device broadcasts this state vector for use by neighboring automobiles. The wireless communication device 108 also receives the state vectors from neighboring automobiles. The received state vectors from the neighboring automobiles are sent to the processor 102 for further processing.

The wireless communication device 108 may be part of a local area wireless network such as an IEEE 802.11 network. The local area network may be a mesh network, ad-hoc network, contention access network or any other type of network. The use of a device that is mesh network enabled according to a widely accepted standard such as 802.11(s) may be a good choice for a wireless communication device 108. The wireless communication device 108 may also feature a transmitter with low broadcast power to allow automobiles in the area to receive the broadcast signal. The broadcast of state vectors over a broad area network or the internet is also contemplated.

The display 110 and the audio cuing device 112 are features that provide the driver with situational awareness. The processor 102 sends commands to the display 110 and the cuing device 112 that alert the driver to hazards. The display 110 may for example show the relative positions and velocities of neighboring vehicles. The display 110 may also warn the driver to slow down or apply the brakes immediately. The audio cuing device 112 may give aural warnings such as “STOP” or “CAUTION VEHICLE APPROACHING”.

The braking and steering systems (not shown) may also be commanded by the processor 102. The processor 102 may command that the brakes be applied to prevent collision with a vehicle ahead or may provide a steering input to prevent the driver from colliding with a vehicle. The processor 102 may also issue braking or steering commands to minimize the damage resulting from a collision.

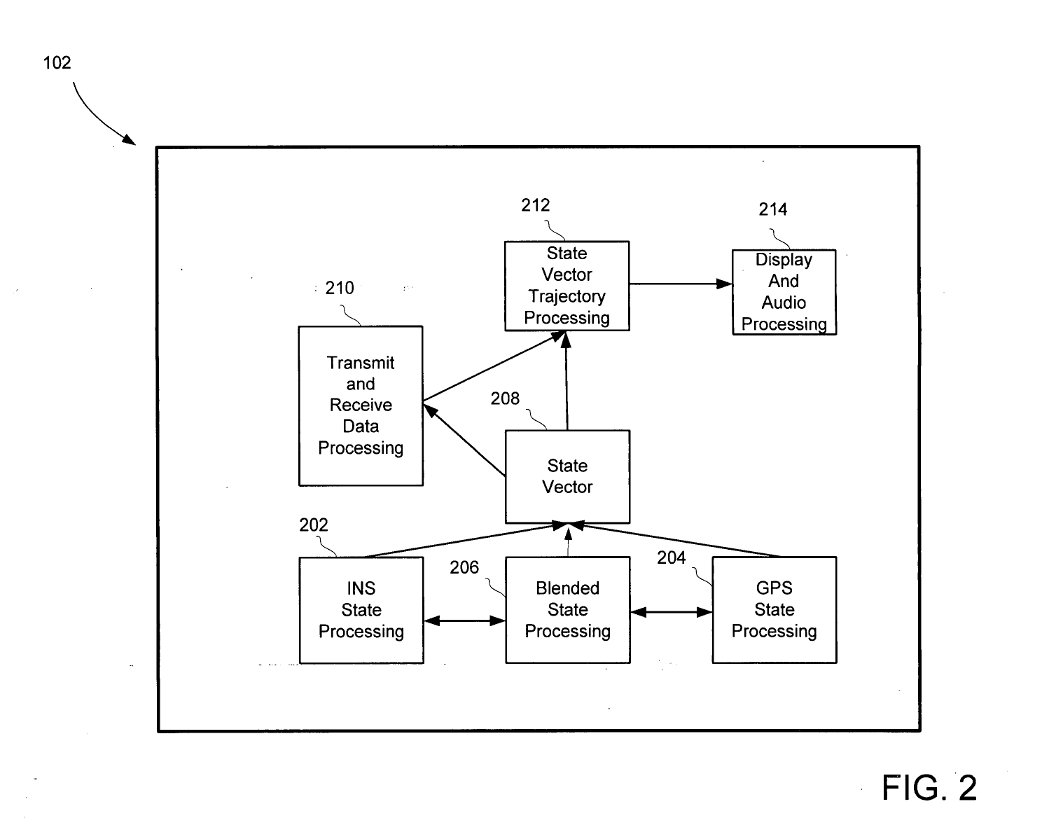

FIG. 2 shows the processor 102 of FIG. 1. The processor 102 receives INS state information from the INS. The INS state processing module 202 uses the INS information to produce an INS state vector. The processor 102 also receives GPS information from the GPS receiver. The GPS state processing module 204 uses the GPS information to produce a GPS state vector. The blended state processing module 206 receives the INS state vector from the INS state processing module 204 and the GPS state vector from the GPS state processing module 204 and produces a blended state vector.

The state vectors from the INS state processing module 202, the GPS state processing module 204 and the blended state processing module 206 are sent to a state vector module 208 that selects an appropriate state vector. The selected state vector is sent to a transmit and receive data processing module 210 that pre-processes data bound for the wireless communication device. The selected state vector is also sent to the state vector trajectory processing module 212. The transmit and receive data processing module 210 also processes state vectors received from the wireless communication device and forwards to the state vectors to the processing module 212.

The state vector processing module generates display and audio information for the display and audio processing module 214. The display and audio processing module 214 generates display and audio cue commands for driving the display and the audio cuing device.

The INS state processing module 202 processes the inertial information and generates an INS state vector. To generate the INS state vector the processor 102 may perform time interpolation. The INS state processing module 202 may also model errors over time in the INS using GPS or blended state information. The INS state processing module 202 may also provide the INS with alignment information and initial position information. The INS state processing module 202 may also monitor the INS for failures or poor performance. The INS state processing module 202 may assign a figure of merit or other indicia of accuracy to the INS state vector.

The GPS state processing module 204 processes the GPS receiver information and generates a GPS state vector. To generate the GPS state vector the processor 102 may perform time interpolation. The GPS state processing module 204 may monitor the GPS receiver for satellite outages. The GPS state processing module 204 may provide position data to the GPS receiver for acquiring or reacquiring satellite timing signals. The GPS state processing module 204 may monitor the GPS receiver for failures or poor performance.

The state vector module 208 chooses an appropriate state vector and may assign indicia of quality to the state vector. The state vector module 208 may monitor the blended, GPS and INS state vector for quality. The state vectors module 208 may nominally choose the blended state vector but may select the GPS or INS state vector if the state vector module 208 determines the GPS or INS state vector is more appropriate. For example the GPS state vector may be the most appropriate state vector if one of the INS accelerometers is failing and there is little confidence in the information received from the INS and therefore the INS state vector or the blended state vector.

The transmit and receive data processing module 210 may receive the most appropriate state vector from the state vector module 208 at regular intervals. The transmit and receive data processing module 210 may format and send the state vector to the wireless communication device. The transmit and receive data processing module 210 may also receive data from the wireless communication device. The data may be unpacked and formatted into state vectors for further processing by the state vector trajectory processing module 212.

The state vector trajectory processing module 212 receives the automobile state vector from the state vector module 208 as well as other vehicles state vectors from the transmit and receive data processing module 210. The state vector trajectory processing module 212 may use the information in the state vectors to predict the position of the automobile and other vehicles over a time interval, for example five seconds. The projected automobile position and other vehicle positions may be checked to see if a collision event is likely.

The trajectory analysis may also include analysis of vehicle trajectory histories. Historical trajectory analysis may be useful, for example, to determine if the automobile and other vehicles are traveling in the same lane of a multiple lane highway. The trajectory analysis may also use driver driving models to allow the state vector trajectory processing module 212 to determine when and if to issue driver warnings. The trajectory analysis may also take into account any self reported accuracy indicators in the state vectors received from other vehicles.

The state vector trajectory processing module 212 may also generate braking or steering commands to send to the automobile's braking and steering systems for preventing a collision or minimizing the damage from a collision.

The state vector trajectory processing module 212 sends information to the display and audio processing module 214. The display and audio processing module 214 formats the information for display. The display and audio processing module 214 generates symbology for the display and the audio cues for the audio cuing device.

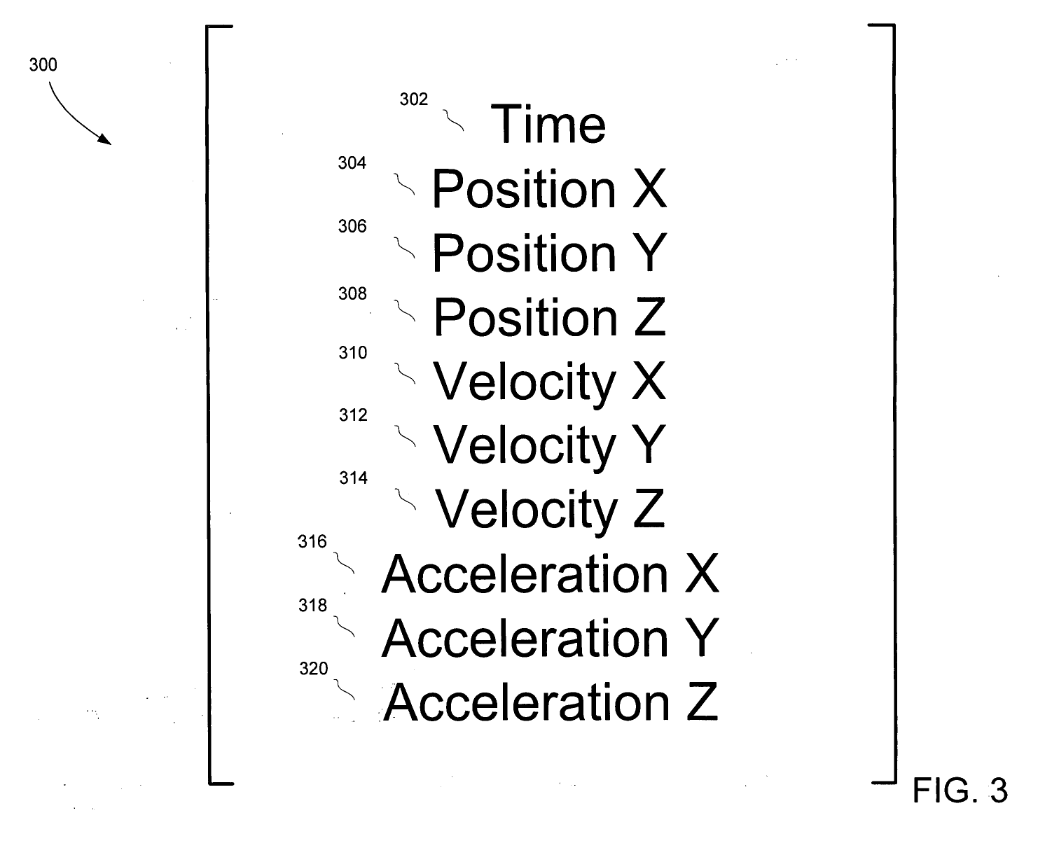

FIG. 3 shows an exemplary state vector 300 processed by the processor 102. The state vector includes the time 302 the state vector was estimated. The state vector also includes the three dimensional position of the automobile in earth centered earth fixed coordinates, shown as position X 304, position Y 306, and position Z 308. The state vector also includes the three dimensional velocity of the automobile in earth centered earth fixed coordinates, shown as velocity X 310, velocity Y 312, and velocity Z 314. The state vector also includes the three dimensional acceleration of the automobile in earth centered earth fixed coordinates, shown as acceleration X 316, acceleration Y 318, and acceleration Z 320.

The state vector shown is exemplary. The automobile state vector may have more or less elements describing the state of the vehicle. For example the state vector may contain entries that describe the angular position, the angular rates, and the angular accelerations. The state vector may be described using any coordinate system or any type of units. The state vector may also contain information about the vehicle such as its weight, stopping distance, its size, its fuel state etc.

Information packed in the state vector may be of value in collision avoidance trajectory analysis or may be useful for generating and displaying more accurate display symbology for the driver. For example, the automobile may receive a state vector from a neighboring vehicle that identifies the vehicle as an eighteen wheel truck with a ten ton load. Such information may be important for trajectory analysis and for providing accurate and informative display symbology.

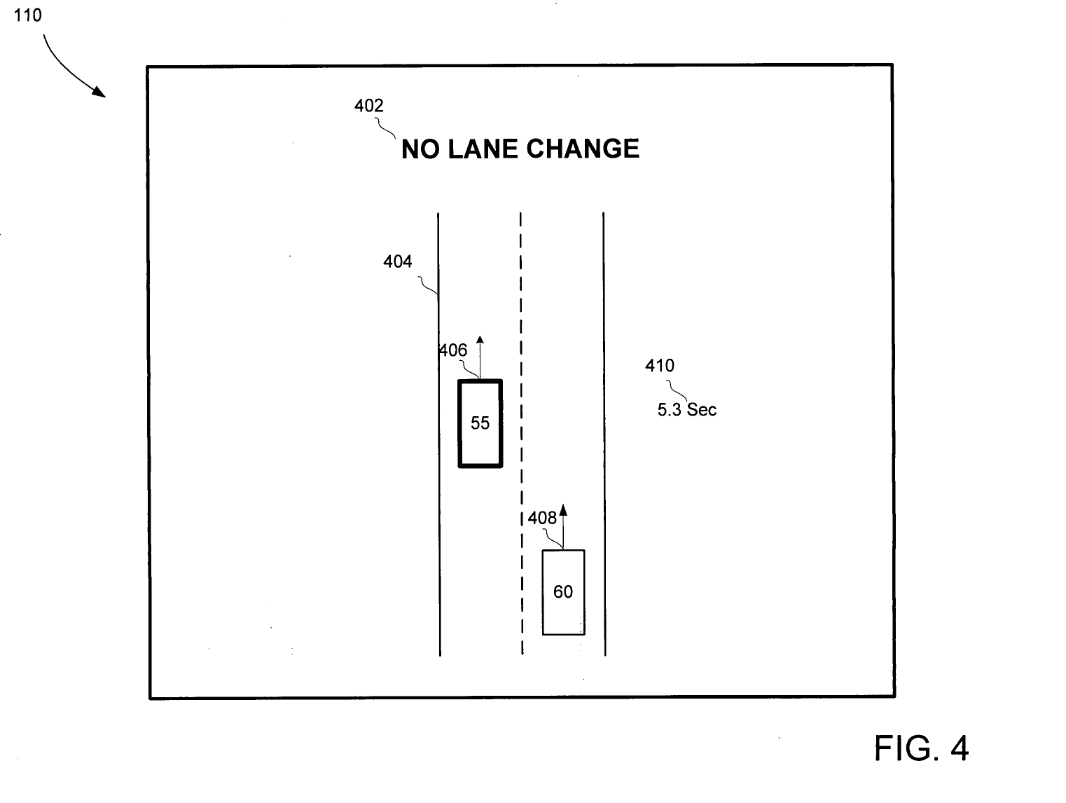

FIG. 4 shows a first exemplary display page that may be shown on the display 110. An annunciation line 402 displays “NO LANE CHANGE” to the driver indicating that a lane change would be unsafe. Road display symbology 404 shows a two lane highway with cars traveling in the same direction. Road display symbology 404 may be generated based on map data stored in a database or determined from state vector data from the automobile and received state vectors from surrounding vehicles.

An automobile symbol 406 has a dark outline indicating that this symbol represents the driver's automobile. A “55 numeric in the automobile symbol 506 alerts the driver of his speed. An arrow extending from the automobile symbol 506 informs the driver of his direction of travel. A vehicle symbol 408 shows that another vehicle is at the five o'clock position relative to the automobile. The numeric 60 inside the vehicle symbol 408 alerts the driver that the vehicle is traveling at sixty miles an hour.

From the display, it is evident that the vehicle may pass by the automobile shortly. Accordingly, the annunciation line 402 alerts the driver that it's unsafe to change lines at this time. This display is particularly valuable when the vehicle represented by the vehicle symbol 408 is in the automobile's blind spot. A countdown timer 410 indicates that 5.3 seconds is the expected amount of time that must elapse before it is safe for the driver to make a lane change. In this case 5.3 seconds may indicate the amount of time required for the vehicle to overtake the automobile clearing the right lane for a safe lane change.

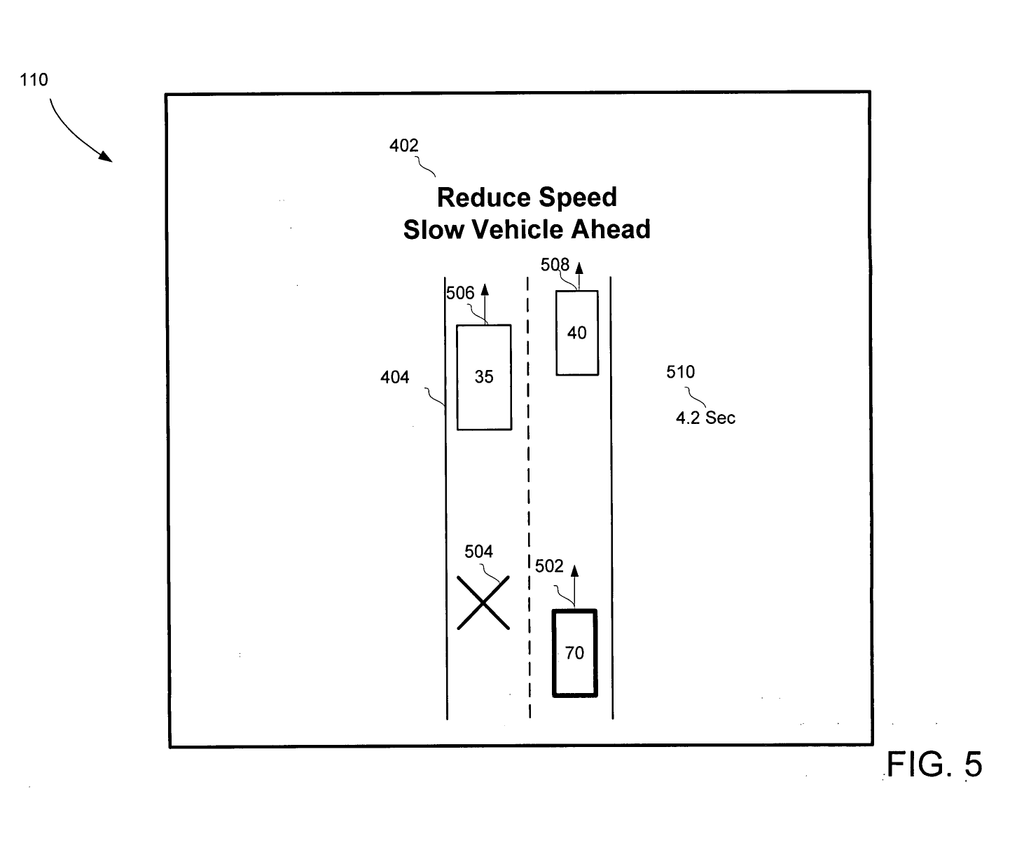

FIG. 5 shows a second exemplary display page that may be shown on the display 110. The annunciation line 402 displays “REDUCE SPEED SLOW VEHICLES AHEAD”. The road display 404 shows a two lane highway with cars traveling in the same direction. The automobile symbol 502 is dark to alert the driver that the symbol represents the driver's automobile. The symbol shows that the automobile is traveling at 70 MPH. An X symbol 504 placed next to the automobile symbol 502 alerts the driver that changing lanes is not recommended.

A first vehicle symbol 506 shows that a first vehicle is ahead of the automobile, in the other lane, and is traveling at 35 miles an hour. A second vehicle symbol 508 shows a second vehicle traveling in the same lane as the automobile at 40 MPH. A countdown timer 510 alerts the driver that in 4.2 seconds the driver's automobile will collide with second Vehicle 508 if the driver does not adjust his speed.

This view might be particularly helpful in fog. The driver is alerted that there is slow traffic ahead and may begin to reduce the speed of the automobile. Anticipating the required speed reduction decreases the chance of collision due to distractions or inattentiveness.

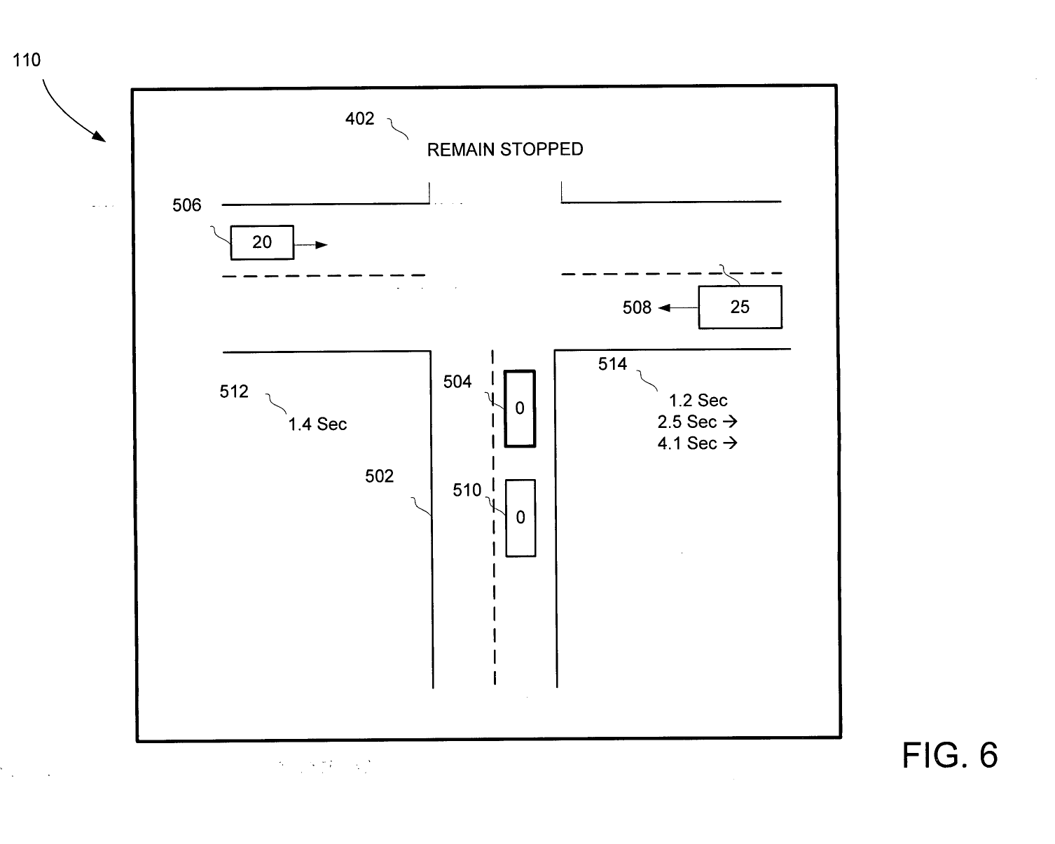

FIG. 6 shows a third exemplary display page that may be shown on the display 110. The annunciation line 402 alerts the driver to remain stopped. Road display symbology 502 shows that the automobile is stopped at an intersection. The automobile symbology 504 has a dark outline to indicate to the driver that the symbol represents the driver's automobile. A first vehicle symbol 506 shows that a first vehicle is approaching the intersection from the left side at 20 MPH. A second vehicle symbol 508 shows that a second vehicle is also approaching the intersection from the right side at 25 MPH. A third vehicle symbol 510 shows that a third vehicle is stopped behind the driver's automobile.

A first countdown timer 512 shows that in 1.4 seconds the first vehicle is expected to finish crossing the intersection. A second countdown timer 514 shows that in 1.2 seconds the second vehicle is expected to finish crossing the intersection. The second countdown timer also shows a 2.5 second and 4.1 second entries with arrows indicating that a fourth and fifth vehicle not shown on the display 110 are expected to finish crossing the intersection.

The driver seeing this display 110 realizes that it will be about 4.1 seconds before it is safe to cross the intersection. This view is particularly useful if the corners adjacent to the driver's automobile are obstructed by buildings or trees. The driver does not have to dangerously “inch up” into the intersection to see the first and second vehicles.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. An automobile collision avoidance apparatus, comprising:
a navigation device for determining a first automobile state vector;
a wireless transmitter for transmitting the first automobile state vector;
a wireless receiver for receiving a second automobile state vector; and
a processor for comparing the first automobile state vector with the second automobile state vector.

2. The apparatus of claim 1 wherein the navigation device has a global positioning system receiver.

3. The apparatus of claim 1 wherein the navigation device has an angular position sensor.

4. The apparatus of claim 3 wherein the angular position sensor is a gyroscope.

5. The apparatus of claim 3 wherein the angular position sensor is a microelectromechanical device.

6. The apparatus of claim 1 wherein the transmitter transmits the first automobile state vector over a wireless local area network.

7. The apparatus of claim 1 wherein the first automobile state vector includes a position and a velocity.

8. The apparatus of claim 1 further comprising a display connected with the processor for displaying a relative position of an automobile determined from the first automobile state vector and the second automobile state vector.

9. A collision avoidance system, comprising:
a global position system receiver for determining a position of a vehicle;
a sensor for determining a velocity of the vehicle;
a wireless transmitter for transmitting the position and the velocity;
a wireless receiver for receiving data from a neighboring vehicle; and
a processor for comparing the position and the velocity of the vehicle with the data from the neighboring vehicle.

10. The collision avoidance system of claim 9 wherein the sensor has an accelerometer.

11. The collision avoidance system of claim 10 wherein the sensor has an angular position sensor.

12. The collision avoidance system of claim 11 wherein the angular position sensor is a gyroscope.

13. The collision avoidance system of claim 9 further comprising a display connected with the processor for displaying the data from the neighboring vehicle.

14. The collision avoidance system of claim 9 wherein the data includes position, velocity, and time for the neighboring vehicle.

15. The collision avoidance system of claim 9 wherein the processor sends a command to the braking system.

16. An apparatus for enhancing automobile safety, comprising:
a global positioning system receiver for determining a first position;
an angular position sensor for determining a first heading;
an accelerometer for determining a first speed;
a transmitter for transmitting the first position, the first heading, and the first speed;
a receiver for receiving a second position, a second heading, and a second speed; and
a processor for comparing the first position, the first heading and the first speed with the second position, the second heading, and the second speed.

17. The apparatus of claim 16 wherein the processor sends a command to issue an audio warning.

18. The apparatus of claim 16 wherein the processor sends a command to issue a visual cue.

19. The apparatus of claim 15 wherein the processor sends a braking command.

20. The apparatus of claim 15 wherein the angular position sensor is a microelectromechanical device.
